(19) United States
(12) Patent Application Publication
(10) Pub. No.: US 2025/0342842 A1
(43) Pub. Date: Nov. 6, 2025

(54) MULTI-CHANNEL TRANSCODER

(71) Applicant: Google LLC, Mountain View, CA (US)

(72) Inventor: Rajeev Nongpiur, Mountain View, CA (US)

(21) Appl. No.: 19/199,782

(22) Filed: May 6, 2025

Related U.S. Application Data
(60) Provisional application No. 63/643,178, filed on May 6, 2024.

(51) Int. Cl. G10L 19/008; G10L 19/16

(52) U.S. Cl. CPC G10L 19/008; G10L 19/173

(57) ABSTRACT

A method including receiving first audio having a first accuracy and a first number of channels and generating second audio based on the first audio, the second audio having a second accuracy and a second number of channels, the first accuracy is a greater spatial accuracy than the second accuracy, the first number of channels is greater than the second number of channels.

### CROSS-REFERENCE TO RELATED APPLICATION

This application claims priority to U.S. Provisional Patent Application No. 63/643,178, filed on May 6, 2024, entitled “MULTI-CHANNEL TRANSCODER”, the disclosure of which is incorporated by reference herein in its entirety.

### BACKGROUND

Encoding, decoding and/or transcoding ambisonic to binaural is typically based on signal processing methods. The signal processing methods are based on linear models. Linear models can have issues such as noise coloring and attenuation at high frequencies for lower order ambisonic signals.

### SUMMARY

Implementations relate to a machine learning (ML) technique to encode, decode, and/or transcode ambisonic signals of any order. The ML technique can use a neural network (or neural networks) configured to model complex non-linear signal relationships. The non-linear signal relationships can be included in the data during training and accounted for during system operation.

In a general aspect, a device, a system, a non-transitory computer-readable medium (having stored thereon computer executable program code which can be executed on a computer system), and/or a method can perform a process with a method including receiving first audio having a first accuracy and a first number of channels and generating second audio based on the first audio, the second audio having a second accuracy and a second number of channels, the first accuracy is a greater accuracy than the second accuracy, the first number of channels is greater than the second number of channels.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1A illustrates a block diagram of a device according to an example implementation.

FIG. 1B illustrates a block diagram of an audio transcoder system according to an example implementation.

FIG. 1C illustrates a block diagram of an audio transcoder model according to an example implementation.

FIG. 2A illustrates a pictorial diagram of an audio data flow according to an example implementation.

FIG. 2B illustrates a block diagram of a data flow for training the audio transcoder model according to an example implementation.

FIG. 3 illustrates a block diagram of a data flow for an audio encoder model according to an example implementation.

FIG. 4 illustrates a block diagram of a data flow for an audio transcoder model according to an example implementation.

FIG. 5 illustrates a block diagram of a data flow for an audio encoder model according to an example implementation.

FIG. 6 illustrates a block diagram of a data flow for an audio decoder model according to an example implementation.

FIG. 7 illustrates a block diagram of a method of transcoding multi-channel audio according to an example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

A device configured to playback audio can include speakers configured for stereo playback. For example, a mobile device can be paired with two earbuds (e.g., one for each ear of a user) configured to generate stereo audio (e.g., stereo soundwaves) based on an audio signal received from the device. In some implementations, the device can receive audio over, for example, the internet. The received audio can have a non-stereo format. Therefore, the device can be configured to convert or transform the received audio from the non-stereo format to a stereo format. The non-stereo format can be a multi-channel audio format. A multi-channel audio format can be an audio format having three or more channels where a stereo audio format has two channels. Accordingly, example implementations can include a device configured to convert or transform multi-channel audio to stereo audio for playback on speakers of the device.

Multi-channel audio including, for example, surround sound audio formats, are sometimes played back on two-channel (e.g., stereo) speakers. Therefore, the multi-channel audio should be converted (e.g., transcoded) into a two-channel audio format for playback on stereo speakers (e.g., headphones). For example, ambisonic signals or ambisonic audio can be in a multi-channel audio format including spherical harmonics coefficients instead of (or based on) microphone-recorded signals. Playback of ambisonic audio on binaural or stereo speakers (e.g., headphones) can include transcoding the ambisonic audio into binaural audio signals. Binaural playback (sometimes called binaural rendering) of ambisonic signals can generate an immersive audio experience to a user wearing headphones.

Channel can relate to the audio signals used in an audio format (or model). The channels often relate to the microphones used to generate the audio and the speakers used to playback the audio. Therefore, the number of channels can be related to the number of microphones and/or speakers used. For example, binaural audio (e.g., stereo audio) used two channels. In some example implementations, multi-channel audio can have three or more channels. Channels on ambisonic audio is often referred to as orders (e.g., first-order ambisonics, second-order ambisonics, . . . , 7th order ambisonics, etc.). For example, first-order ambisonics can have 4, 6, or 8 channels based on the number of speakers used. For example, second-order ambisonics can have nine channels or speakers, 5th order ambisonics can have 36 channels or speakers, 7th order ambisonics can have 64 channels or speakers, and the like. In other words, in ambisonics the higher the order, the greater the number of channels or speakers.

Current techniques for transcoding multi-channel audio rely on signal processing algorithms (e.g., an algorithm based on a linear model). At least one technical problem with relying on signal processing algorithms can include noise coloring and attenuation at high frequencies, especially for lower order multi-channel audio signals. Noise coloring can include generating undesirable audio during the transcoding process. The noise colors can include white noise including every band in the noise spectrum, pink noise including noise having a power density that reduces 3 dB per octave (sometimes called inverse flicker noise), brown noise including noise having low-frequency bass tones, pink noise including noise having low frequency and high frequency audio, gray noise including noise having equal power at every frequency, green noise including noise having audio at the center of the frequency spectrum and having a limited frequency range, black noise including noise having audio at the bottom of the spectrum for the human ear, and the like.

At least one technical solution to the technical problem noted above can include using a model (e.g., a machine learning model) to transcode multi-channel audio. The model can be configured to model complex non-linear relationships between low-order audio signals and high-order audio signals. The model can be data driven based on available multi-channel audio used to train the model.

At least one technical effect can be the generating of high-order audio signals during the transcoding process. The addition of high-order audio signals can improve the listening experience of a user of an audio playback device (e.g., speakers).

In some implementations of the technical solution, the multi-channel audio can be ambisonic audio. Ambisonic audio can be a spherical surround sound audio format. In other words, ambisonic audio can be audio in a horizontal plane (e.g., like stereo), and a vertical plane (e.g., above and below a listener). Generally, ambisonic audio does not include signals targeted for specific speakers (e.g., there are more audio channels than speakers). Accordingly, in some implementations, transcoding multi-channel audio can include transcoding ambisonic audio signals into binaural audio signals. Binaural audio can be stereo audio signals targeted for playback on a head worn device (e.g., headphones, earplugs, and the like). Therefore, some implementations can include using a model (e.g., a machine learning model) to transcode ambisonic audio signals into binaural audio signals.

Spatial audio or 3D audio, refers to sound design and technology that mimics the natural way humans perceive sound in a three-dimensional space. As mentioned above, in some implementations, multi-channel audio refers to ambisonic audio. In ambisonic audio, order can refer to an audio or sound field at a point in space having a level or degree of accuracy or spatial accuracy (e.g., accuracy in a two-dimensional audio environment, accuracy in a three-dimensional audio environment) or details (also a certain number of channels). Alternatively, or in addition, order can refer to a level or degree of spatial accuracy or detail (also a certain number of channels) that an audio or sound field can be reproduced. Therefore, order can refer to sound field order or spatial-accuracy where first-order is a sound field order or spatial-accuracy, second-order is a sound field order or spatial-accuracy, etc. Spatial accuracy can be referred to as accuracy, audio accuracy, or spatial audio accuracy. Spatial accuracy refers to how well a sound system can create a realistic and precise 3D soundscape, allowing the listener to accurately perceive the location of sound sources.

In some implementations, an ambisonic audio can have a first accuracy, first spatial accuracy, first spatial audio accuracy, and/or the like. Further, stereo audio can have a second accuracy, second spatial accuracy, second spatial audio accuracy, and/or the like. In other words, ambisonic audio and stereo audio can have different accuracy or spatial associated with how well a sound system can create a realistic and precise 3D soundscape, allowing the listener to accurately perceive the location of sound sources. In some implementations, ambisonic audio can have a higher accuracy or spatial accuracy as compared to stereo audio. In other words, a sound system can create a more realistic and precise 3D soundscape using ambisonic audio as compared to stereo audio. Therefore, ambisonic audio allows the listener to more accurately perceive the location of sound sources as compared to stereo audio.

Low-order audio signals or low-order ambisonics has less spatial accuracy as compared to high-order audio signals or high-order ambisonics. For example, first-order ambisonics includes a sound field that captures only the omnidirectional (zero-order) and the sound events occurring along the X, Y, and Z-axis (for a total of four (4) directions). Therefore, the number of channels in first-order ambisonics is four (4). As the ambisonics order becomes higher, the directions between the axis can be captured. For example, third-order ambisonics includes sound fields of the first-order (four directions) and second-order (four (4)+five (5) or nine (9)) as well as sound events occurring along seven (7) additional directions between the X, Y, and Z-axis and uses 16 channels. Further, fourth-order ambisonics has 25 directions and 25 channels, and so on. The number of channels can be associated with the number of directions in the sound field. In ambisonic audio, 7th-order, 10th-order, and higher can be used.

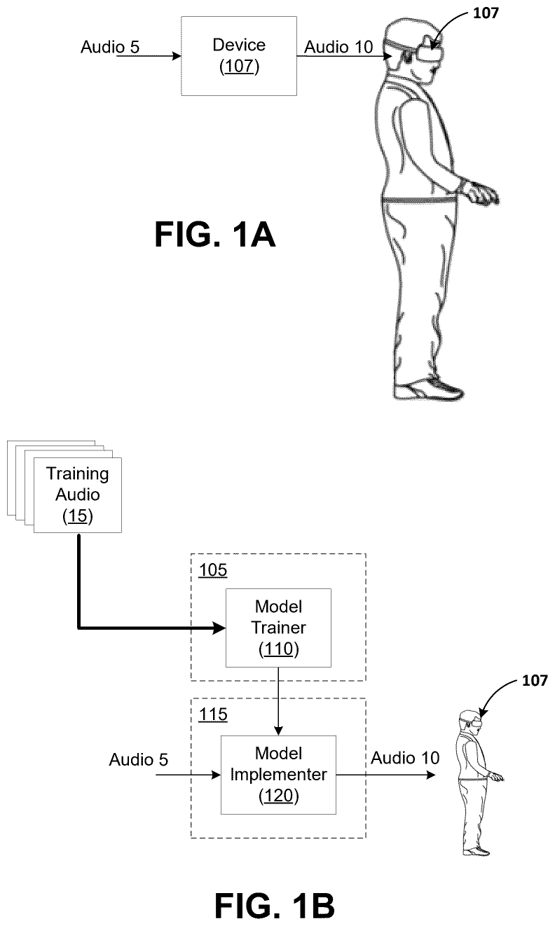

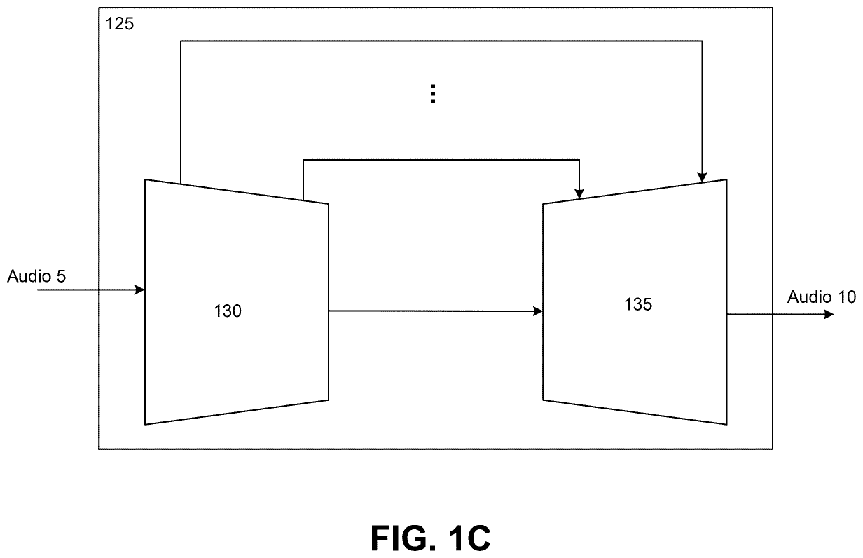

FIG. 1A illustrates a block diagram of device according to an example implementation. As shown in FIG. 1A, device 107 can receive audio 5 and generate audio 10 for playback by device 107. For example, device 107 can include speakers (e.g., earphones) configured to playback audio in a stereo format (sometimes referred to as a binaural format). Therefore, audio 10 should be generated as stereo audio. Audio 5 can be an ambisonic audio signal. In some implementations, input audio 5 can be a multi-channel audio signal. For example, input audio 5 can be an ambisonic audio signal. In some implementations, output audio 10 can be a binaural audio signal. Therefore, the device 107 can be configured to convert (e.g., transcode) audio 5 as an ambisonic audio signal to audio 10 as a stereo signal for playback on device 107.

FIG. 1B illustrates a block diagram of an audio transcoder system according to an example embodiment. As shown in FIG. 1B, an audio transcoder system can include a first computing device 105 and a second computing device 115. The first computing device 105 includes a model trainer 110 block and the second computing device 115 can include a model implementer 120 block. The first computing device 105 can be associated with a product manufacturer and can be implemented in, for example, a server, a networked computer, a main frame computer, a local computer, and/or the like. The second computing device 115 can be a user device and can be implemented in, for example, a computing device (e.g., device 107). The computing device can include, for example, an AR headset, a mobile device, a laptop device, a cell phone, a personal computer, and/or the like. The computing device can include a stereo speaker. The second computing device 115 can have limited computing resources as compared to the first computing device 105.

The model trainer 110 can be configured to train a model (e.g., a statistical model, a neural network (e.g., CNN), a linear network, an encoder-decoder network, and/or the like). During training, the model can be configured to predict binaural audio or stereo audio signal targeted for playback on a head worn device (e.g., headphones, earplugs, and the like), for example, an AR headset (e.g., device 107).

In some implementations, neural network architecture refinements can include layer type modification(s). For example, some implementations can experiment with different or additional neural network layers. For example, if long-range temporal dependencies are crucial and not fully captured by the STFT and CNN combination, recurrent neural network (RNN) layers could be incorporated.

In some implementations, neural network architecture refinements can include network dimension modification(s). For example, some implementations can adjust the depth (number of layers) or width (number of units per layer) of the encoder and decoder sections.

In some implementations, neural network architecture refinements can include activation function and Normalization modification(s). For example, some implementations can test alternative activation functions within the CNN layers or different normalization techniques to potentially improve training stability and performance.

In some implementations, neural network architecture refinements can include attention mechanism modification(s). For example, some implementations can implement attention mechanisms. These could allow the network to weigh different parts of the input ambisonic signal more heavily when generating the binaural (or other format) output, potentially improving the accuracy of spatialization or the handling of complex audio scenes.

In some implementations, neural network architecture refinements can include loss function modification(s) For example, some implementations can explore different loss functions during the model training phase. The choice of loss function can impact how the network prioritizes different aspects of the decoding task.

In some implementations, neural network architecture refinements can include STFT Parameter modification(s). For example, some implementations can fine-tune the parameters of the Short-Time Fourier Transform (e.g., window size, hop size, type of windowing function) as these can affect the frequency-domain representation fed into the neural network.

As shown in FIG. 1B, the training data can be a plurality of training audio 15. The training audio 15 can be used to train the model for binaural audio prediction for each training audio 15. For example, the model can include a plurality of weights that are modified after each training iteration until a loss is minimized and/or a change in loss or losses associated with the model is minimized.

The model implementer 120 (e.g., associated with the second computing device 115) can include the trained (and possibly tuned) model. Thus, the model implementer 120 may be said to use the model in an operational or binaural prediction phase or mode. The model implementer 120 can be configured to determine (e.g., predict) an audio 10 associated with an audio 5. The audio 5 can be an ambisonic audio signal. Therefore, the audio 10 can be associated with (e.g., played back by) a user of the device 107. In an example implementation, the model can be a transcoder configured to predict the audio 10 based on audio 5. The model implementer 120 can be configured to calibrate the model (e.g., further modifying the weights) based on audio associated with a user of device 107. In this implementation, the model implementer 120 may include both the trained model and the modified trained model. In this implementation, the trained model can be further trained by the user (or a technician working with the user) and the parameters and/or weights associated with the further trained model can be used by the modified trained model. In some implementations, the model implementer 120 may have access to the trained model, e.g., at the first computing device 105, for the calibration.

The training audio 15 can be real data (e.g., recorded ambisonic audio) and/or synthetic data (e.g., computer generated audio). Real data and/or synthetic data may be in the form of ambisonic audio. Real data can be time-consuming to obtain and therefore obtaining sufficient real data to robustly train models associated with a transcoder system can be impractical. To address this issue, example implementations can train a first model (or first compound model) that can be robustly trained using the limited real data and the synthetic data. This first model can then be modified into a second model (or second compound model) for use in a user device including an operational transcoder system. The second model may use less processing resources than the first model, making the second model appropriate for resources typically associated with a user device.

Multi-channel audio including, for example, surround sound audio formats, are sometimes played back on two-channel (e.g., stereo) speakers. Therefore, the multi-channel audio should be converted (e.g., transcoded) into a two-channel audio format for playback on stereo speakers (e.g., headphones). Some implementations can use a machine learning (ML) technique to encode, decode, and/or transcode multi-channel (e.g., ambisonics) audio signals. FIG. 1C illustrates a block diagram of an audio transcoder model according to an example implementation.

As shown in FIG. 1C, an audio transcoder model 125 can include an audio encoder 130 and an audio decoder 135. The audio transcoder model 125 can be configured to generate output audio 10 based on input audio 5. In other words, audio transcoder model 125 can be configured to transcode input audio 5 into output audio 10. In some implementations, input audio 5 can be a multi-channel audio signal. For example, input audio 5 can be an ambisonic audio signal. In some implementations, output audio 10 can be a binaural audio signal. In some implementations, the audio transcoder model 125 can be a machine learning model. Therefore, the audio encoder 130 can be a machine learning model and the audio decoder 135 can be a machine learning model. The machine learning model can be a neural network. For example, the machine learning model can be a convolutional neural network (CNN).

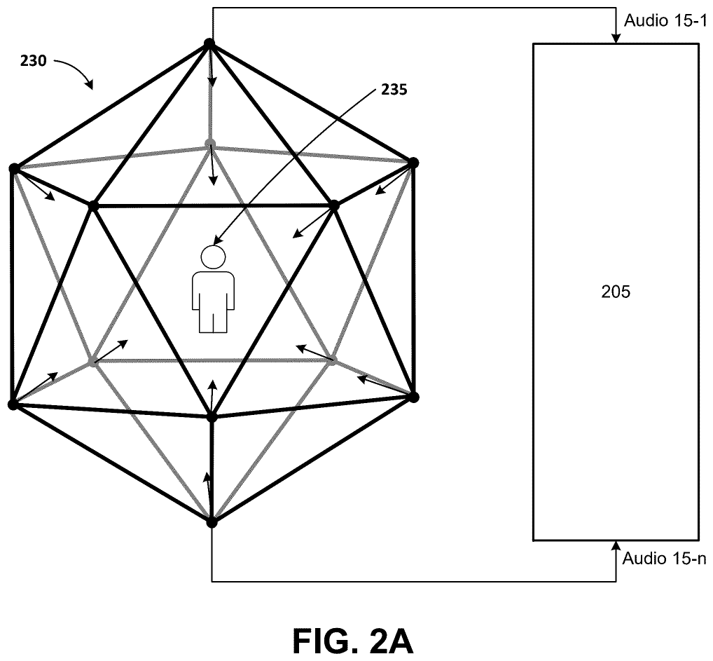

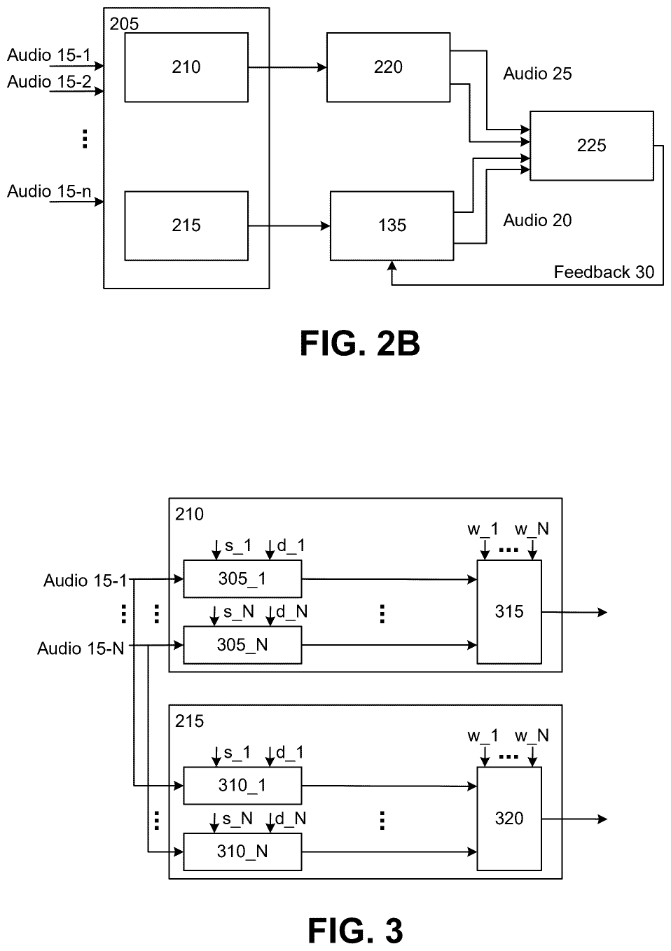

FIG. 2A illustrates a pictorial diagram of an audio data flow according to an example implementation. As shown in FIG. 2A, the audio data flow can include an ambisonic model 230 and an audio encoder 205 (described below). In the example implementation of FIG. 2A, the ambisonic model 230 includes N audio channels. The audio channels can be represented by dots at the line intersections in the geodesic polyhedron representing the ambisonic model 230. Each channel has an arrow representing an audio direction with respect to user 235. In each direction, planar waves can be propagating from evenly spaced directions. Ambisonics (ambisonic audio, ambisonic model, etc.) can relate to a 360-degree surround sound audio format. Ambisonics can be used to capture and reproduce audio to create a full (or substantially full) sphere of sound around a listener. Ambisonics differs from traditional stereo or surround sound in that ambisonics can be configured to encode the sound field rather than individual speaker signals. Ambisonics is often implemented together with 360-degree video. In some implementations, the two or more time-delayed channels can be read and used in the generation of the ambisonic model 230. A portion of the N audio channels can be communicatively coupled to the audio encoder 205. The portion of the N audio channels can be used in the transcoding of the ambisonic model 230 as audio 5.

The ambisonic model 230 can be defined as an audio source based on polygons on a geodesic polyhedron such as an icosahedron, geodesic polyhedrons subdivision or other (geodesic) polyhedra, and/or point sources. Each point on the polygon can correspond to an audio channel of an audio source (e.g., an ambisonic microphone). Therefore, the ambisonic model 230 can have N audio channels. If the ambisonic model is based on a geodesic polyhedron (as shown in FIG. 2A), the ambisonic model 230 can have, for example, 10, 12, 15, 20, and the like audio channels.

FIG. 2B illustrates a block diagram of a data flow for training the audio transcoder model according to an example implementation. In some implementations, the audio transcoder model 125 can be a machine learning model. Accordingly, in some implementations, the data flow of FIG. 2B can be used for training the audio transcoder model 125 and/or elements of the audio transcoder model 125. As shown in FIG. 2B, the dataflow can include an audio encoder 205. The audio encoder 205 can include a high-order audio encoder 210 and a low-order audio encoder 215. As shown in FIG. 2B, the dataflow can further include an audio converter 220, the audio decoder 135, and a training module 225.

In some implementations, the training of the audio transcoder model can use audio 25 as target binaural signals (sometimes called ground-truth data) that are generated by using audio 15-1, 15-2 (e.g., ambisonic audio). The audio 15-1, 15-2 can be audio of a higher order. The audio 15-1, 15-2, . . . 15-n can be mono audio signals. In some implementations, audio 15-1, 15-2, . . . 15-n can be mono audio signals representing multi-channel audio. Alternatively, or in addition, audio 15-1, 15-2, . . . 15-n can be mono audio signals generated based on a multi-channel audio. In other words, each of audio 15-1, 15-2, . . . 15-n can correspond to an audio channel of the multi-channel audio signal.

In some implementations, the audio transcoder model 125 can be configured to transcode a multi-channel audio signal of a pre-defined order. In some implementations, the pre-defined can include low-order channels. In FIG. 2B, audio 15-1 can be the highest-order channel and audio 15-n can be the lowest-order channel. For example, the audio transcoder model 125 can be configured to transcode a six (6) channel audio signal (e.g., six (6) order). Therefore, the audio transcoder model 125 can be trained based on audio 15-n, 15-(n-1), 15-(n-2), 15-(n-3), 15-(n-4), and 15-(n-5). A six (6) channel audio signal is only an example. The audio transcoder model 125 can be configured to transcode three (3) channel audio, four (4) channel audio, five (5) channel audio, . . . , 16 channel audio, 17 channel audio, 18 channel audio, and etc.

The low-order audio encoder 215 can be configured to encode mono audio signals based on the pre-defined order of the audio transcoder model 125 and a spatial position of the mono audio signals. The high-order audio encoder 210 can be configured to encode mono audio signals based on the remainder of the audio 15-1, 15-2, . . . 15-n. The audio encoder 205 can be configured to select the pre-defined audio 15-1, 15-2, . . . 15-n for the high-order audio encoder 210 and the low-order audio encoder 215. Audio converter 220 can be configured to convert the encoded audio generated by the high-order audio encoder 210 into audio 25 (e.g., binaural audio). Audio decoder 135 can be configured to generate audio 20 (e.g., binaural audio) based on the encoded audio generated by the low-order audio encoder 215. In some implementations, the audio decoder 135 can predict audio 20. Predicting audio 20 can include predicting audio having a higher order than the audio input to the low-order audio encoder 215. Audio decoder 135 and audio converter 220 can be configured to generate binaural audio. However, audio decoder 135 and audio converter 220 can be configured to generate any other audio format (e.g., any other stereo or surround sound audio format).

In some implementations, predicting audio can include using a model (e.g., a trained model, a machine learned model, and the like) to identify features associated with an input audio signal (e.g., first audio signal) and use the features to generate an output audio signal (e.g., second audio signal). In some implementations, the input audio signal can be a multi-channel audio (e.g., ambisonic audio) signal and the output audio can be a binaural audio (e.g., stereo audio) signal. In some implementations, the model can be configured to convert the input audio into a spectrogram, identify features associated with the spectrogram, classify the features, convert the classified features to a format associated with the output audio signal, generate a spectrogram using the converted features, and generate the output audio based on the spectrogram.

The training module 225 can be configured to generate feedback 30 based on a comparison of audio 20 and audio 25. Feedback 30 can be used to train audio decoder 135. The audio decoder 135 can be a model. Therefore training the audio decoder 135 can include, for example, modifying parameters, modifying weights, modifying biases, modifying weights and/or biases of a convolution layer(s), modifying biases, modifying weights and/or biases of a connected layer(s), and/or the like. The comparison of audio 20 and audio 25 can be a high-order comparison. The comparison of audio 20 and audio 25 can be based on a loss. Audio 15-1, 15-2, . . . 15-n can be training data. Any audio can be selected (e.g., input) as audio 15-1, 15-2, . . . 15-n. The audio can be speech, music, nature, and the like. In some implementations, audio 15-1, 15-2, . . . 15-n can include a mixture of sounds (e.g., speech and music) from various sources and directions.

FIG. 3 illustrates a block diagram of a data flow for an audio encoder model according to an example implementation. As shown in FIG. 3, the high-order audio encoder 210 can include a spread factor s_1, . . . , s_N and a direction d_1, . . . , d_N as input to high-order audio encoder 305_1, . . . , 305_N. Further, the low-order audio encoder 215 can include spread factor s_1, . . . , s_N and direction d_1, . . . , d_N input to low-order audio encoder 310_1, . . . , 310_N.

In some implementations, a spread factor s_1, . . . , s_N can be a variable indicating an audio signal spread over frequency and time. In some implementations, a direction d_1, . . . , d_N can be a variable from zero (0) to 360 degrees indicating an angle at which an audio signal is received from. In some implementations, the spread factor s_1, . . . , s_N can be a random number. In some implementations, the direction d_1, . . . , d_N can be a random angle. In some implementations, spread factor s_1, . . . , s_N can be varied for each input of audio 15-1, 15-2, . . . 15-n. In other words, spread factor s_1, . . . , s_N can be varied for each training iteration. In some implementations, the direction d_1, . . . , d N can be a random angle. In some implementations, direction d_1, . . . , d_N can be varied for each input of audio 15-1, 15-2, . . . 15-n. In other words, direction d_1, . . . , d_N can be varied for each training iteration.

As shown in FIG. 3, the data flow for the audio encoder model can include a weighted sum module 315, 320. The weighted sum module 315, 320 can have a weighted input variable weight w_1, . . . , w_N. In some implementations, weight w_1, . . . , w_N associated with weighted sum module 315 can be the same as (or equal to) weight w_1, . . . , w_N associated with weighted sum module 320. In some implementations, weight w_1, . . . , w_N associated with weighted sum module 315 can be different from (or not equal to) weight w_1, . . . , w_N associated with weighted sum module 320. In some implementations, a portion of (or a subset of) weight w_1, . . . , w_N associated with weighted sum module 315 can be the same as (or equal to) a portion of (or a subset of) weight w_1, . . . , w_N associated with weighted sum module 320. In some implementations, a portion of (or a subset of) weight w_1, . . . , w_N associated with weighted sum module 315 can be different from (or not equal to) a portion of (or a subset of) weight w_1, . . . , w_N associated with weighted sum module 320. In some implementations, weight w_1, . . . , w_N can be varied for each input of audio 15-1, 15-2, . . . 15-n. In other words, direction weight w_1, . . . , w_N can be varied for each training iteration.

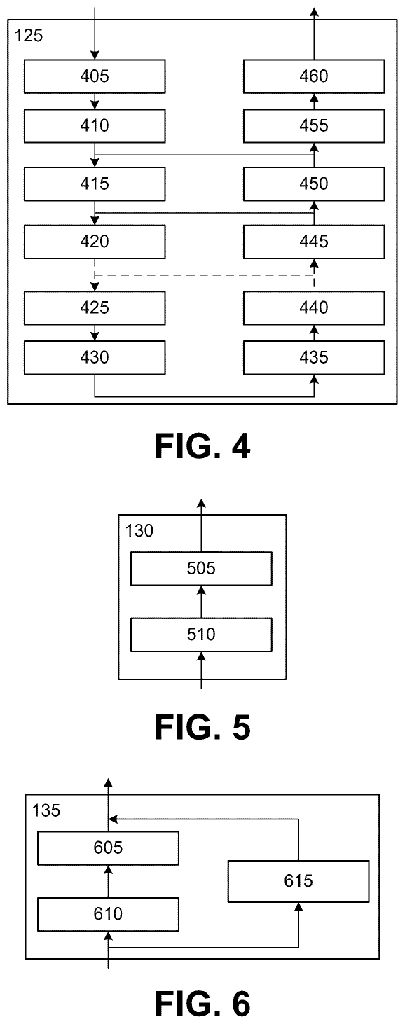

FIG. 4 illustrates a block diagram of a data flow for an audio transcoder model according to an example implementation. In some implementations, the audio transcoder model can be a CNN-based encoder-decoder architecture operating in the frequency domain using the Short-Time Fourier Transform (STFT). As shown in FIG. 4, the audio transcoder model can include an STFT block 405, an inv-STFT block 460, a CNN block 410, 430, 455, 435, an encoder block 415, 420, 425, and a decoder block 440, 445, 450.

As shown in FIG. 4 the STFT block 405 receives an input audio. As shown in FIG. 1C, the input audio can be audio 5. Therefore, the STFT block 405 can be configured to perform a STFT on audio 5 for input to CNN block 410. STFT block 405 can be configured to convert the time-domain input signal of audio 5 to a frequency domain signal for CNN block 410 to process and/or determine audio characteristics of audio 5 in the frequency domain.

Then encoder block 415, 420, 425 can encode the audio characteristics, then the encoded audio characteristics can be classified by CNN block 430. The classified audio characteristics are then sent through an inverse process including CNN block 435, 455, decoder block 440, 445, 450, and inv-STFT block 460. The inverse process can be configured to convert the classified audio characteristics which are based on multichannel audio to binaural or stereo audio as, for example, audio 10.

FIG. 5 illustrates a block diagram of a data flow for an audio encoder model according to an example implementation. In some implementations, the audio encoder 130 model can represent encoder blocks 415, 420, 425. As shown in FIG. 5, the audio encoder 130 model can include a two-dimensional (2D) convolution 505 (e.g., CNN) and a transposed-2D convolution 510 (e.g., a transposed-2D CNN). 2D convolution 505 can be configured to extract spatial features associated with the input audio (e.g., audio 5). For example, the convolutional layers of 2D convolution 505 can be trained to extract relevant features from the input audio, such as the presence of specific frequencies, changes in frequency over time, and spatial correlations within the audio signal. Transposed-2D convolution 510 can be configured to increase the spatial resolution (e.g., increase the spatial dimensions) of the extracted audio features.

In some implementations, the 2D convolution 505 can be configured as an encoder configured to extract features and reduce the spatial dimensions. In some implementations, the transposed-2D convolution 510 can be configured as a decoder configured to upsample the encoded representation to reconstruct a higher-resolution version of the input (or a related output, such as a mask for audio separation).

FIG. 6 illustrates a block diagram of a data flow for an audio decoder model according to an example implementation. In some implementations, the audio decoder 135 model can represent decoder blocks 440, 445, 450. As shown in FIG. 6, the audio decoder 135 model can include a two-dimensional (2D) convolution 605 (e.g., CNN), a transposed-2D convolution 610 (e.g., a transposed-2D CNN), and an up-sample and projection block 615.

Referring to FIGS. 4, 5, and 6, the audio transcoder model architecture can operate in the frequency domain, employing the Short-Time Fourier Transform (STFT) to convert the time-domain input signal. The model then utilizes convolutional neural networks (CNNs) for efficient processing before the output is returned to the time domain via the inverse-STFT. This efficient architecture allows for seamless on-device implementation.

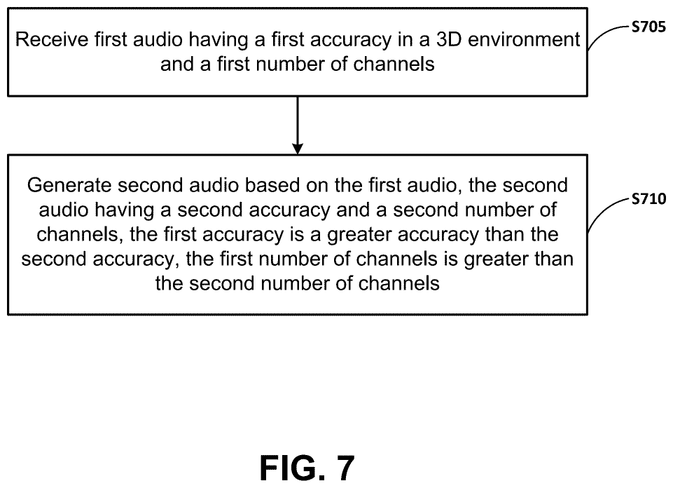

Example 1. FIG. 7 is a block diagram of a method of transcoding multi-channel audio according to an example implementation. As shown in FIG. 7, in step S705 receive first audio having a first accuracy and a first number of channels. In step S710 generate second audio based on the first audio, the second audio having a second accuracy and a second number of channels, the first accuracy is a greater accuracy than the second accuracy, the first number of channels is greater than the second number of channels. In some implementations, accuracy can be a spatial-accuracy is associated with the spatial accuracy of a sound field. In some implementations, accuracy can be a spatial-accuracy is associated with the order (e.g., first-order, second-order, low-order, high-order, and the like) of a sound field.

Example 2. The method of Example 1, wherein the generating of the second audio can use a model.

Example 3. The method of Example 2, wherein the model is a machine learning model.

Example 4. The method of Example 1, wherein the generating of the second audio can use a transcoder.

Example 5. The method of Example 4, wherein the transcoder can include an encoder and a decoder.

Example 6. The method of Example 5, wherein the encoder can be a machine learning-based encoder and the decoder can be a machine learning-based decoder.

Example 7. The method of Example 1, wherein the first audio can be ambisonics audio and the second audio can be binaural audio.

Example 8. The method of Example 1, wherein the first audio can include spherical harmonics coefficients associated with the first number of channels.

Example 9. The method of Example 1, wherein the first audio can be encoded audio, and the generating of the second audio can include decoding the first audio with a model configured to model complex non-linear relationships between low-order audio signals and high-order audio signals.

Example 10. The method of Example 9, wherein the model can be a machine learning model trained to model the complex non-linear relationships between low-order audio signals and high-order audio signals.

Example 11. The method of Example 1 further includes playing back the second audio on a device including speakers configured to playback binaural audio

Example 12. A method can include any combination of one or more of Example 1 to Example 11.

Example 13. A non-transitory computer-readable storage medium comprising instructions stored thereon that, when executed by at least one processor, are configured to cause a computing system to perform the method of any of Examples 1-12.

Example 14. An apparatus comprising means for performing the method of any of Examples 1-12.

Example 15. An apparatus comprising at least one processor and at least one memory including computer program code, the at least one memory and the computer program code configured to, with the at least one processor, cause the apparatus at least to perform the method of any of Examples 1-12.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed is:

1. A method comprising:
receiving first audio having a first accuracy in a three-dimensional environment and a first number of channels; and
generating second audio based on the first audio, the second audio having a second accuracy in the three-dimensional environment and a second number of channels, wherein the first accuracy is greater than the second accuracy and the first number of channels is greater than the second number of channels.

2. The method of claim 1, wherein
the first accuracy is at least one of a spatial-accuracy associated with a first sound field or a spatial-accuracy associated with an order of the first sound field, and
the second accuracy is at least one of a spatial-accuracy associated with a second sound field or a spatial-accuracy associated with an order of the second sound field.

3. The method of claim 1, wherein the first audio includes spherical harmonics coefficients associated with the first number of channels.

4. The method of claim 1, wherein
the first audio is encoded audio, and
the generating of the second audio includes decoding the first audio with a model configured to model complex non-linear relationships between low-order audio signals and high-order audio signals.

5. The method of claim 4, wherein
the model is a machine learning model trained to model the complex non-linear relationships between low-order audio signals and high-order audio signals, and
the model is a machine learning model trained in two training operations where a second training is based on user feedback.

6. The method of claim 1, further comprising playing back the second audio on a device including speakers configured to playback binaural audio.

7. The method of claim 6, wherein
the generating of the second audio uses a transcoder including an encoder and a decoder,
the encoder is a machine learning-based encoder, and
the decoder is a machine learning-based decoder.

8. The method of claim 1, wherein the first audio is ambisonics audio and the second audio is binaural audio.

9. An apparatus comprising at least one processor and at least one memory including computer program code, the at least one memory and the computer program code configured to, with the at least one processor, cause the apparatus to:
receive first audio having a first accuracy in a three-dimensional environment and a first number of channels; and
generate second audio based on the first audio, the second audio having a second accuracy in the three-dimensional environment and a second number of channels, wherein the first accuracy is greater than the second accuracy and the first number of channels is greater than the second number of channels.

10. The apparatus of claim 9, wherein the first audio includes spherical harmonics coefficients associated with the first number of channels.

11. The apparatus of claim 9, wherein
the first audio is encoded audio, and
the generating of the second audio includes decoding the first audio with a model configured to model complex non-linear relationships between low-order audio signals and high-order audio signals.

12. The apparatus of claim 11, wherein the model is a machine learning model trained to model the complex non-linear relationships between low-order audio signals and high-order audio signals.

13. The apparatus of claim 9, further comprising playing back the second audio on a device including speakers configured to playback binaural audio.

14. The apparatus of claim 9, wherein
the generating of the second audio uses a transcoder including an encoder and a decoder,
the encoder is a machine learning-based encoder, and
the decoder is a machine learning-based decoder.

15. The apparatus of claim 9, wherein the first audio is ambisonics audio and the second audio is binaural audio.

16. A non-transitory computer-readable storage medium comprising instructions stored thereon that, when executed by at least one processor, are configured to cause a computing system to:
receive first audio having a first accuracy in a three-dimensional environment and a first number of channels; and
generate second audio based on the first audio, the second audio having a second accuracy in the three-dimensional environment and a second number of channels, wherein the first accuracy is greater than the second accuracy and the first number of channels is greater than the second number of channels.

17. The non-transitory computer-readable storage medium of claim 16, wherein
the first audio is encoded audio, and
the generating of the second audio includes decoding the first audio with a model configured to model complex non-linear relationships between low-order audio signals and high-order audio signals.

18. The non-transitory computer-readable storage medium of claim 17, wherein the model is a machine learning model trained to model the complex non-linear relationships between low-order audio signals and high-order audio signals.

19. The non-transitory computer-readable storage medium of claim 16, wherein
the first accuracy is at least one of a spatial-accuracy associated with a first sound field or a spatial-accuracy associated with an order of the first sound field, and
the second accuracy is at least one of a spatial-accuracy associated with a second sound field or a spatial-accuracy associated with an order of the second sound field.

20. The non-transitory computer-readable storage medium of claim 16, further comprising playing back the second audio on a device including speakers configured to playback binaural audio.
